(19) United States
(12) Patent Application Publication
(10) Pub. No.: US 2023/0402585 A1
(43) Pub. Date: Dec. 14, 2023

(54) LITHIUM-ION BATTERY INCLUDING ANODE-FREE CELLS

(71) Applicant: GM GLOBAL TECHNOLOGY OPERATIONS LLC, Detroit, MI (US)

(72) Inventors: Yong LU, Shanghai (CN); Zhe LI, Shanghai (CN); Meiyuan WU, Shanghai (CN); Haijing LIU, Shanghai (CN)

(73) Assignee: GM GLOBAL TECHNOLOGY OPERATIONS LLC, Detroit, MI (US)

(21) Appl. No.: 17/879,210

(22) Filed: Aug. 2, 2022

(30) Foreign Application Priority Data
Jun. 8, 2022 (CN) 202210640898.3

(51) Int. Cl. H01M 4/36; H01M 10/0525

(52) U.S. Cl. CPC H01M 4/366; H01M 10/0525; H01M 2004/027

(57) ABSTRACT

A hybridized lithium-ion battery that includes one or more positive electrode assemblies is provided. Each of the one or more positive electrode assemblies includes a positive electrode current collector and one or more positive electroactive material layers disposed on one or more surfaces of the positive electrode current collector. The hybridized lithium-ion battery also includes two or more negative electrode current collectors, and one or more negative electroactive material layers disposed on one or more surfaces of at least one of the two or more negative electrode current collectors, where a total number of the one or more positive electroactive material layers is greater than a total number of negative electroactive material layers. The hybridized lithium-ion battery also includes two or more separating layers physically separating the positive electrode assemblies and the negative electroactive material layers or the positive electrode assemblies and the negative electrode current collectors.

### CROSS-REFERENCE TO RELATED APPLICATIONS

This application claims the benefit and priority of Chinese Application No. 202210640898.3 filed Jun. 8, 2022. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”).

### SUMMARY

This section provides a general summary of the disclosure, and is not a comprehensive disclosure of its full scope or all of its features.

The present disclosure relates to hybridized batteries including both traditional lithium-ion electrochemical cells and anode-free, lithium-ion electrochemical cells, and methods of making and using the same.

In various aspects, the present disclosure provides a hybridized lithium-ion battery. The hybridized lithium-ion battery may include one or more positive electrode assemblies, where each of the one or more positive electrode assemblies includes a positive electrode current collector and one or more positive electroactive material layers disposed on or near one or more surfaces of the positive electrode current collector. The hybridized lithium-ion battery may also include two or more negative electrode current collectors, and one or more negative electroactive material layers disposed on or near one or more surfaces of at least one of the two or more negative electrode current collectors, where a total number of the one or more positive electroactive material layers is greater than a total number of negative electroactive material layers. The hybridized lithium-ion battery may also two or more separating layers that physically separate the positive electrode assemblies and the negative electroactive material layers or the positive electrode assemblies and the negative electrode current collectors.

In one aspect, a first positive electrode assembly of the one or more positive electrode assemblies together with a first negative electrode current collector of the two or more negative electrode current collectors, a first negative electroactive material layer of the one or more negative electroactive material layers disposed on or near a first surface of the first negative electrode current collector facing the positive electrode assembly, and a first separating layer of the two or more separating layers disposed between the positive electrode assembly and the first negative electroactive material layer may define a first cell.

In one aspect, the first positive electrode assembly may include a first positive electroactive material layer disposed on a first side of a second positive electrode current collector and a second positive electroactive material layer disposed on a second side of the second positive electrode current collector, where the first positive electroactive material layer is adjacent to the first separating layer. The second positive electroactive material layer together with a second negative electrode current collector of the two or more negative electrode current collectors, and a second separating layer of the two or more separating layers disposed between the second positive electroactive material layer and the second negative electrode current collector may define a second cell. The second negative electrode current collector may contact the second separating layer.

In one aspect, a second negative electroactive material layer of the one or more negative electroactive material layers may be disposed on a surface of the second negative electrode current collector facing away from the second separating layer. The second negative electroactive material layer together with a second positive electrode assembly, and a third separating layer of the two or more separating layers disposed between the second negative electroactive material layer and the second positive electrode assembly may define a third cell.

In one aspect, a second negative electroactive material layer of the one or more negative electroactive material layers may be disposed on a surface of the first negative electrode current collector. The second negative electroactive material layer together with a second positive electrode assembly, and a third separating layer of the two or more separating layers disposed between the second negative electroactive material layer and the second positive electrode assembly may define a third cell.

In one aspect, the first negative electrode current collector together with a second positive electrode assembly and a second separating layer of the two or more separating layers disposed between the first negative electrode current collector and the second positive electrode assembly may define a second cell. The second separating layer may contact the first negative electrode current collector.

In one aspect, the second positive electrode assembly may include a first positive electroactive material layer disposed on a first side of a second positive electrode current collector and a second positive electroactive material layer disposed on a second side of the second positive electrode current collector, where the first positive electroactive material layer is adjacent to the second separating layer. The second positive electroactive material layer together with a second negative electrode current collector, and a third separating layer of the two or more separating layers disposed between the second positive electroactive material layer and the second negative electrode current collector may define a third cell.

In one aspect, a second negative electroactive material layer may be disposed on a surface of the second negative electrode current collector facing away from the third separator. The second negative electroactive material layer together with a third positive electrode assembly and a fourth separating layer of the two or more separating layers disposed between the second negative electroactive material layer and the third positive electrode assembly may define a fourth cell.

In one aspect, the battery may have a negative electrode capacity for lithium to positive electrode capacity for lithium (N/P) ratio of greater than 1.0.

In various aspects, the present disclosure provides a hybridized lithium-ion battery. The hybridized lithium-ion battery may include a first cell and a second cell. The first cell may include a first negative electrode current collector and a first positive electroactive material layer physically separated by a first separating layer. The first negative electrode current collector may contact the first separating layer. The second cell may include a second negative electrode current collector, a negative electroactive material layer disposed on a first side of the second negative electrode current collector, and a second positive electroactive material layer. The negative electroactive material layer and the positive electroactive material layer may be physically separated by a second separating layer. The hybridized lithium-ion battery may also include a positive electrode current collector disposed between the first positive electroactive material layer and the second positive electroactive material layer.

In one aspect, the negative electroactive material layer may be a first negative electroactive material layer, and the positive electrode current collector may be a first positive electrode current collector. The hybridized lithium-ion battery may further include a second negative electroactive material layer adjacent to a surface of the first negative electrode current collector facing away from the first separating layer, a positive electrode assembly comprising a third positive electroactive material layer and a second positive electrode current collector, and a third separating layer physically separating the second electroactive material layer and the positive electrode assembly.

In one aspect, the negative electroactive material layer may be a first negative electroactive material layer, and the positive electrode current collector may be a first positive electrode current collector. The hybridized lithium-ion battery may further include a second negative electroactive material layer adjacent to a second side of the second negative electrode current collector, a positive electrode assembly comprising a third positive electroactive material layer and a second positive electrode current collector, and a third separating layer physically separating the second electroactive material layer and the positive electrode assembly.

In one aspect, the positive electrode current collector may be a first positive electrode current collector. The hybridized lithium-ion battery may further include a third separating layer adjacent to a side of the first negative electrode current collector facing away from the first separating layer, and a positive electrode assembly adjacent to the third separating layer. The positive electrode assembly may include a third positive electroactive material layer and a second positive electrode current collector.

In one aspect, the battery may have a negative electrode capacity for lithium to positive electrode capacity for lithium (N/P) ratio of greater than 1.0.

In various aspects, the present disclosure provides a hybridized lithium-ion battery. The hybridized lithium-ion battery may include a first positive electrode current collector, a first positive electroactive material layer disposed on a surface of the first positive electrode current collector, a first separating layer disposed on a surface of the first positive electroactive material layer, a negative electroactive material layer disposed on a surface of the first separating layer, a negative electrode current collector disposed on a surface of the negative electroactive material layer, a second separating layer disposed on a surface of the first negative electrode current collector, a second positive electroactive material layer disposed on a surface of the second separating layer, and a second positive electrode current collector disposed on a surface of the second positive electroactive material layer.

In one aspect, the negative electroactive material layer may be a first negative electroactive material layer, and the negative electrode current collector may be a first negative electrode current collector. The battery may further include a third positive electroactive material layer disposed on a surface of the second positive electrode current collector, a third separating layer disposed on a surface of the third positive electroactive material layer, a second negative electroactive material layer disposed on a surface of the third separating layer, and a second negative electrode current collector disposed on a surface of the second negative electroactive material layer.

In one aspect, the negative electrode current collector may be a first negative electrode current collector. The battery may further include a third positive electroactive material layer disposed on a surface of the second positive electrode current collector, a third separating layer disposed on a surface of the third positive electroactive material layer, and a second negative electrode current collector disposed on a surface of the third separating layer.

In one aspect, the negative electroactive material layer may be a first negative electroactive material layer. The battery may further include a second negative electroactive material layer disposed on a surface of the second negative electrode current collector facing away from the third separating layer, a fourth separating layer disposed on or near a surface of the second negative electroactive material layer, a fourth positive electroactive material layer disposed on or near a surface of the fourth separating layer, and a third positive electrode current collector disposed on or near a surface of the fourth positive electroactive material layer.

In one aspect, the negative electrode current collector may be a first negative electrode current collector. The battery may further include a third positive electroactive material layer disposed on a surface of the first positive electrode current collector facing away from the first positive electroactive material layer, a third separating layer disposed on the third positive electroactive material layer, and a second negative electrode current collector disposed on the third separating layer.

In one aspect, the battery may have a negative electrode capacity for lithium to positive electrode capacity for lithium (N/P) ratio of greater than 1.0.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of a traditional lithium-ion electrochemical cell in accordance with various aspects of the present disclosure;

FIG. 2 is an illustration of an anode-free, lithium-ion electrochemical cell in accordance with various aspects of the present disclosure;

FIG. 3 is an illustration of an example hybridized battery including both traditional lithium-ion electrochemical cells and anode-free, lithium-ion electrochemical cells in accordance with various aspects of the present disclosure;

FIG. 4A is a graphical illustration demonstrating a formation cycle of an example hybridized battery including both traditional lithium-ion electrochemical cells and anode-free, lithium-ion electrochemical cells in accordance with various aspects of the present disclosure; and

FIG. 4B is graphical illustration demonstrating a first cycle after a formation cycle of an example hybridized battery including both traditional lithium-ion electrochemical cells and anode-free, lithium-ion electrochemical cells in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure relates to hybridized batteries including both traditional lithium-ion electrochemical cells and anode-free, lithium-ion electrochemical cells, and methods of making and using the same. Such batteries can be used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example.

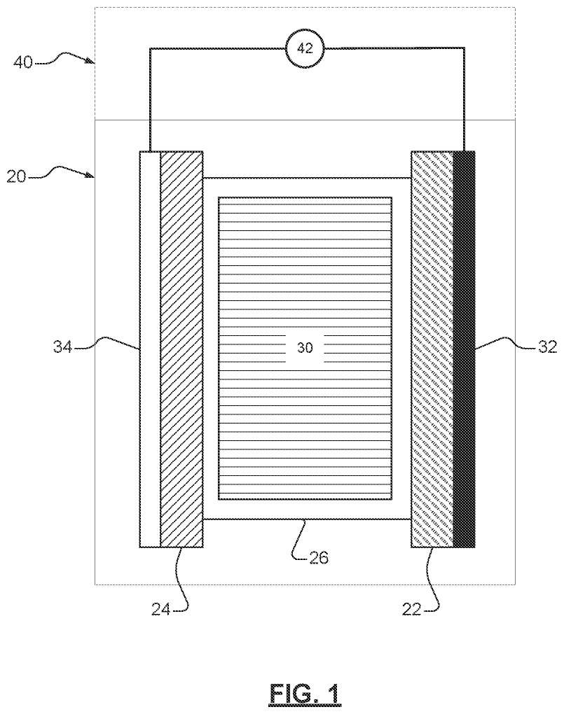

An exemplary and schematic illustration of a traditional lithium-ion electrochemical cell 20 is shown in FIG. 1. The lithium-ion electrochemical cell 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown), and in certain instances, the semi-solid state electrolyte may at least partially fill voids or openings between the solid-state electrolyte particles. In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative electrode current collector) may be positioned at or near the negative electrode 22. The first current collector 32 may be a metal foil, metal grid or screen, or expanded metal comprising copper or any other appropriate electrically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). For example, the lithium-ion electrochemical cell 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the lithium-ion electrochemical cell 20 is diminished.

The positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion electrochemical cell 20. For example, in certain aspects, the electrolyte 30 may be a non-aqueous liquid electrolyte solution (e.g., >0.8 M) that includes a lithium salt dissolved in an organic solvent or a mixture of organic solvents. Numerous conventional non-aqueous liquid electrolyte solutions may be employed in the lithium-ion electrochemical cell 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiFSI), lithium bis(trifluoromethanesulfonyl)imide (LiTFSI), lithium difluoro(oxalato)boarate (LiDFOB), lithium bis(perfluoroethysulfonyl) imide (LiBETI), lithium trifluoroethoxysulfonyl (LiTfO), and combinations thereof.

In various aspects, the lithium salt may be selected from the group consisting of: lithium difluoro(oxalato)boarate (LiDFOB), lithium bis(trifluoromethanesulfonyl)imide (LiTFSI), lithium bis(fluorosulfonyl)imide (LiN(FSO₂)₂) (LiFSI), lithium bis(perfluoroethysulfonyl) imide (LiBETI), lithium hexafluorophosphate (LiPF₆), lithium tetrafluoroborate (LiBF₄), lithium hexafluoroarsenate (LiAsF₆), lithium perchlorate (LiClO₄), lithium trifluoroethoxysulfonyl (LiTfO), and combinations thereof.

In still further variations, the non-aqueous liquid electrolyte may include a first salt and a second salt, where the first salt is selected from the group consisting of: lithium difluoro(oxalato)boarate (LiDFOB), lithium bis(trifluoromethanesulfonyl)imide (LiTFSI), lithium bis(fluorosulfonyl)imide (LiN(FSO₂)₂) (LiFSI), lithium bis(perfluoroethysulfonyl) imide (LiBETI), lithium hexafluorophosphate (LiPF₆), lithium tetrafluoroborate (LiBF₄), lithium hexafluoroarsenate (LiAsF₆), lithium perchlorate (LiClO₄), lithium trifluoroethoxysulfonyl (LiTfO), and combinations thereof.

In each variation, the lithium salt(s) may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

In certain variations, the non-aqueous liquid electrolyte may also include one or more electrolyte additives. The one or more electrolyte additives may include vinylene carbonate (VC), butylene carbonate (BC), fluoroethylene carbonate (FEC), vinyl sulfate (DTD), tris(trimethylsilane) phosphate (TMSP), ethylene carbonate (VEC), InCl₃, ZnCl₂, and the like.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

In still further variations, the separator 26 may be a high-temperature separator including, for example only, polyimide nanofiber-based nonwovens, nano-sized alumina (Al₂O₃) and poly(lithium 4-styrenesulfonate)-coated polyethylene membrane, silica (SiO₂) coated polyethylene separators, co-polyimide-coated polyethylene separators, polyetherimides (bisphenol-aceton diphthalic anhydride and para-phenylenediamine) separator, expanded polytetrafluoroethylene reinforced polyvinylidenefluoride-hexafluoropropylene separator, sandwiched-structured polyvinylidene difluoride (PVdF)/poly(m-phenylene isophthalamide (PMIA)/polyvinylidene difluoride (PVdF) nanofibrous separators, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) layer and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may have an average thickness greater than or equal to about 1 μm to less than or equal to about 1,000 μm, and may include a plurality of solid-state electrolyte particles. In certain variations, the solid-state electrolyte particles may include oxide-based solid-state particles, metal-doped or aliovalent-substituted oxide solid-state particles, sulfide-based solid-state particles, nitride-based solid-state particles, hydride-base solid-state particles, halide-based solid-state particles, borate-based solid-state particles, and/or inactive solid-state oxide particles.

The oxide-based solid-state particles may include, for example only, garnet type solid-state particles (e.g., Li₇La₃Zr₂O₁₂), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where O≤x≤2) (LAGP)), and/or LISICON type solid-state particles (e.g., Li₂₊₂ₓZn₁₋ₓGeO₄, where 0<x<1). The metal-doped or aliovalent-substituted oxide solid-state particles may include, for example only, aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{Y}P_{3-y}O₁₂ (where 0<x<2 and 0<y<3). The sulfide-based solid-state particles may include, for example only, Li₂S—P₂S₅ systems, Li₂S—P₂S₅-MOx systems (where M is Zn, Ca, or Mg, and 0<x<3), Li₂S—P₂S₅-MSx systems (where M is Si, or Sn, and 0<x<3), Li₁₀GeP₂S₁₂ (LGPS), Li_{3.25}Ge_{0.25}P_{0.75}S₄ (thio-LISICON), Li_{3.45}Ge_{0.4}P_{0.6}S₄, Li₁₀GeP₂S_{11.7}O_{0.3}, lithium argyrodite (Li₆PS₅X, where X is Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}AS_{0.166}S₄, LiI—Li₄SnS₄, and/or Li₄SnS₄. The nitride-based solid-state particles may include, for example only, Li₃N, Li₇PN₄, and/or LiSi₂N₃. The hydride-base solid-state particles may include, for example only, LiBH₄, LiBH₄—LiX (where X is Cl, Br, or I), LiNH₂, Li₂NH, LiBH₄₋LiNH₄, and/or Li₃AlH₆. The halide-based solid-state particles may include, for example only, LiI, Li₃InCl₆, Li₂CdCl₄, Li₂MgCl₄, Li₂CdI₄, Li₂ZnI₄, and/or Li₃OCl. The borate-based solid-state particles may include, for example only, Li₂B₄O₇ and/or Li₂O—B₂O₃—P₂O₅.

In certain variations, the semi-solid or gel electrolyte may at least partially fill voids or openings between the solid-state electrolyte particles. In other variations, the porous separator 26 as illustrated in FIG. 1 may be replaced with a free-standing semi-solid or gel membrane. In each instance, the semi-solid or gel electrolyte may include greater than or equal to about or exactly 0.1 wt. % to less than or equal to about or exactly 50 wt. % of the polymer host, and greater than or equal to about or exactly 5 wt. % to less than or equal to about or exactly 90 wt. % of a non-aqueous liquid electrolyte, such as detailed above. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. The semi-solid or gel electrolyte may also be found in the positive and/or negative electrodes 22, 24.

With renewed reference to FIG. 1, the positive electrode 24 may be formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. In certain variations, the positive electrode 24 may include a plurality of solid-state electrolyte particles (not shown). In each instance, the positive electrode 24 may have an average thickness greater than or equal to about 1 μm to less than or equal to about 1,000 μm, optionally greater than or equal to about 1 μm to less than or equal to about 500 μm, and in certain aspects, optionally greater than or equal to about 10 μm to less than or equal to about 200 μm.

In various aspects, the positive electrode 24 may comprise one or more positive electroactive materials having a spinel structure (such as, lithium manganese oxide (Li₍₁₊ₓ₎Mn₂O₄, where 0.1≤x≤1) (LMO) and/or lithium manganese nickel oxide (LiMn₍₂₋ₓ₎NiₓO₄, where 0≤x≤0.5) (LNMO) (e.g., LiMn_{1.5}Ni_{0.5}O₄)); one or more materials with a layered structure (such as, lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}N_{0.33}Co_{0.33}O₂) (NMC), and/or a lithium nickel cobalt metal oxide (LiNi_{(1-x-y)}CoₓM_{y}O₂, where 0<x<0.2, y<0.2, and M may be Al, Mg, Ti, or the like); and/or a lithium iron polyanion oxide with olivine structure (such as, lithium iron phosphate (LiFePO₄) (LFP), lithium manganese-iron phosphate (LiMn₂₋ₓFeₓPO₄, where 0<x<0.3) (LFMP), and/or lithium iron fluorophosphate (Li₂FePO₄F)). In certain variations, the positive electrode 24 may comprise one or more positive electroactive materials selected from the group consisting of: NCM 111, NCM 532, NCM 622, NCM 811, NCMA, LFP, LMO, LFMP, LLC, and combinations thereof.

In certain variations, the positive electroactive material may be optionally intermingled (e.g., slurry casted) with one or more electronically conductive materials that provide an electron conductive path and/or at least one polymeric binder material that improves the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 95 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the at least one polymeric binder.

Example polymeric binders include polyimide, polyamic acid, polyamide, polysulfone, polyvinylidene difluoride (PVdF), polyvinylidene difluoride (PVdF) copolymers, polytetrafluoroethylene (PTFE), polytetrafluoroethylene (PTFE) copolymers, poly acrylic acid, blends of polyvinylidene fluoride and polyhexafluoropropene, poly chlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 may be formed from a lithium host material that is capable of functioning as a negative terminal of a lithium-ion battery. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, in certain variations, the negative electrode 22 may include a plurality of solid-state electrolyte particles (not shown). In each instance, the negative electrode 22 (including the one or more layers) may have a thickness greater than or equal to about 1 μm to less than or equal to about 1,000 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil having an average thickness greater than or equal to about 0 nm to less than or equal to about 500 μm, and in certain aspects, optionally greater than or equal to about 50 nm to less than or equal to about 50 μm. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like). In further variations, the negative electrode 22 may include a silicon-based electroactive material. In still further variations, the negative electrode 22 may include a combination of negative electroactive materials. For example, the negative electrode 22 may include a combination of the silicon-based electroactive material (i.e., first negative electroactive material) and one or more other negative electroactive materials. The one or more other negative electroactive materials may include, for example only, carbonaceous materials (such as, graphite, hard carbon, soft carbon, and the like) and/or metallic active materials (such as tin, aluminum, magnesium, germanium, and alloys thereof, and the like). For example, in certain variations, the negative electrode 22 may include a carbonaceous-silicon based composite including, for example, about or exactly 10 wt. % of a silicon-based electroactive material and about or exactly 90 wt. % graphite.

In certain variations, the negative electroactive material may be optionally intermingled (e.g., slurry casted) with one or more electronically conductive materials that provide an electron conductive path and/or at least one polymeric binder material that improves the structural integrity of the negative electrode 22. For example, the negative electrode 22 may include greater than or equal to about 0 wt. % to less than or equal to about 99.5 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.01 wt. % to less than or equal to about 10 wt. %, of the at least one polymeric binder.

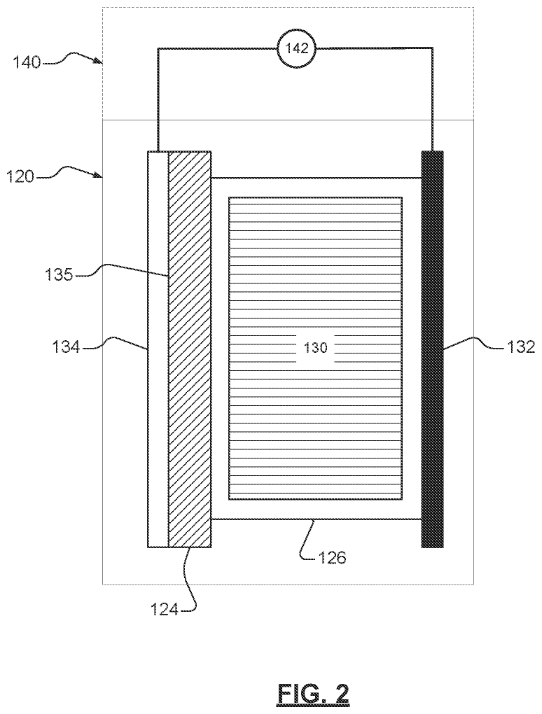

An exemplary and schematic illustration of an anode-free, lithium-ion electrochemical cell 120 is shown in FIG. 2. The anode-free, lithium-ion electrochemical cell 120 includes a first current collector 132 (e.g., a negative electrode current collector) and a second current collector 134 (e.g., a positive current collector). Like the first current collector 32 illustrated in FIG. 1, the first current collector 132 may be a metal foil, metal grid or screen, or expanded metal comprising copper or any other appropriate electrically conductive material known to those of skill in the art. Similarly, like the second current collector 34 illustrated in FIG. 1, the second current collector 134 may be a metal foil, metal grid or screen, or expanded metal comprising aluminum or any other appropriate electrically conductive material known to those of skill in the art.

A positive electrode 124, like the positive electrode 24 illustrated in FIG. 1, may be positioned at or near a first surface 135 of the second current collector 134, and a separator 126, like the separator 26 illustrated in FIG. 1, may be disposed between the positive electrode 124 and the negative electrode current collector 132. The positive electrode 124 and the separator 126 may each include an electrolyte solution or system 130 inside their pores, capable of conducting lithium ions between the first current collector 132 and the positive electrode 124. Like the electrolyte 30 illustrated in FIG. 1, any appropriate electrolyte 130, whether in solid, liquid, or gel form, capable of conducting lithium ions between the first current collector 132 and the positive electrode 124 may be used in the lithium-ion electrochemical cell 120. As would be recognized by the skilled artisan, lithium is deposited or plated on surfaces of first current collector 132 opposing the positive electrode 124, and the charge-discharge process of the anode-free, lithium-ion electrochemical cell 120 is similar to the charge-discharge process of the lithium-ion electrochemical cell 20 illustrated in FIG. 1 including, for example, a lithium metal anode.

The first current collector 132 and the second current collector 134 may respectively collect and move free electrons to and from an external circuit 140. For example, an interruptible external circuit 140 and a load device 142 may connect the first current collector 132 and the positive electrode 124 (through the second current collector 134). For example, the anode-free, lithium-ion electrochemical cell 120 can generate an electric current during discharge by way of reversible electrochemical reactions that occur when the external circuit 140 is closed (to connect the first current collector 132 and the positive electrode 124) and the first current collector 132 including deposited or plated lithium has a lower potential than the positive electrode. The chemical potential difference between the positive electrode 124 and the first current collector 132 drives electrons produced by a reaction, for example, the oxidation of deposited or plated lithium during the charge process, at the first current collector 132 through the external circuit 140 toward the positive electrode 124. Lithium ions at the first current collector 132 are concurrently transferred through the electrolyte 130 contained in the separator 126 toward the positive electrode 124. The electrons flow through the external circuit 140 and the lithium ions migrate across the separator 126 containing the electrolyte 130 to form intercalated lithium at the positive electrode 124. As noted above, the electrolyte 130 is typically also present in the positive electrode 124. The electric current passing through the external circuit 1140 can be harnessed and directed through the load device 42 until the lithium at the first current collector 132 is depleted and the capacity of the lithium-ion electrochemical cell 20 is diminished.

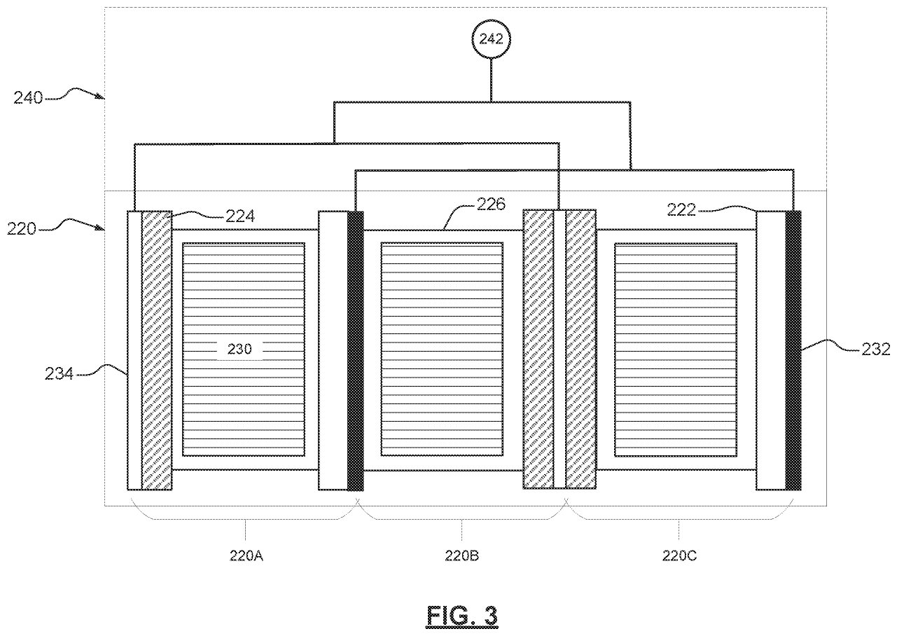

An exemplary and schematic illustration of an example hybridized battery 220 including both traditional lithium-ion electrochemical cells (like the lithium electrochemical cell 20 illustrated in FIG. 1) and anode-free, lithium-ion electrochemical cells (like the anode-free, lithium-ion electrochemical cell 120 illustrated in FIG. 2) is shown in FIG. 3. As illustrated, the hybridized battery 220 includes first, second, and third cells 220A-220C. The first and third cells 220A, 220C may be traditional lithium-ion electrochemical cells including, like the lithium-ion electrochemical cell 20 illustrated in FIG. 1, a first or negative electrode assembly and a second or positive electrode assembly separated by a separator 226 and/or electrolyte 230, where the negative electrode assembly includes a first current collector (i.e., negative electrode current collector) 232 and a first or negative electroactive material layer (i.e., negative electrode) 222, and the positive electrode assembly includes a second current collector (i.e., positive electrode current collector) 234 and a second or positive electroactive material layer (i.e., positive electrode) 224.

The second cell 220B may be an anode-free, lithium-ion electrochemical cell including a first or negative electrode assembly and a second or positive electrode assembly separated by a separator 226 and/or electrolyte 230, where the negative electrode assembly includes a first current collector (i.e., negative electrode current collector) 232 and the positive electrode assembly includes a second current collector (i.e., positive electrode current collector) 234 and a second or positive electroactive material layer (i.e., positive electrode) 224. That is, the anode-free, lithium-ion electrochemical cell may omit the first or negative electroactive material layer (i.e., negative electrode) 222. However, during an initial charge process, lithium metal may be deposited or plated on surfaces of the first current collector 232 near or adjacent to the separator 226. As illustrated, the second cell 220B may share the negative electrode current collector 232 with the first cell 220A, and also the positive electrode current collector 234 with the third cell 220C.

Although only three cells are illustrated, it should be understood that the hybridized battery 220 may include one or more other cells and that the one or more other cells may be lithium-ion electrochemical cells like the first and/or third cells 220A, 220C or anode-free, lithium-ion electrochemical cells like the second cell 220B. It should also be understood that although a lithium-ion electrochemical cell—anode-free, lithium-ion electrochemical cell—lithium-ion electrochemical cell configuration is illustrated the cells defining the hybridized battery 220 may be arranged in a variety of configurations including, for example only, lithium-ion electrochemical cell— lithium-ion electrochemical cell—anode-free, lithium-ion electrochemical cell or lithium-ion electrochemical cell—anode-free, lithium-ion electrochemical cell— anode-free, lithium-ion electrochemical cell—lithium-ion electrochemical cell or anode-free, lithium-ion electrochemical cell—lithium-ion electrochemical cell— anode-free, lithium-ion electrochemical cell or anode-free, lithium-ion electrochemical cell—lithium-ion electrochemical cell—lithium-ion electrochemical cell—anode-free, lithium-ion electrochemical cell. The hybridized battery 220 should have a lithium-ion electrochemical cell: anode-free, lithium-ion electrochemical cell ratio greater than or equal to about 50.01% to less than or equal to about 99.99%, and in certain aspects, optionally greater than or equal to about 80% to less than or equal to about 95%, in capacity. In each variation, the hybridized battery 220 may have a negative electrode capacity for lithium to positive electrode capacity for lithium (N/P) ratio of greater than 1.0.

The first current collectors 232 and the second current collectors 234 may respectively collect and move free electrons to and from an external circuit 240. For example, an interruptible external circuit 240 and a load device 242 may connect the first current collectors 232 and the positive electrodes 224 (through the second current collector 234). For example, the hybridized battery 220 can generate an electric current during discharge by way of reversible electrochemical reactions that occur when the external circuit 240 is closed (to connect the first current collectors 232 and the positive electrodes 224) and the first current collectors 232 including deposited or plated lithium and/or negative electrodes 222 have a lower potential than the positive electrodes 224. The chemical potential difference between the positive electrodes 224 and the first current collectors 232 and/or negative electrodes 222 drives electrons produced by a reaction, for example, the oxidation of deposited or plated lithium, at the first current collectors 232 and/or intercalated lithium at the negative electrodes 222 through the external circuit 240 toward the positive electrodes 224. Lithium ions that are also produced at the first current collectors 232 and/or negative electrodes 222 are concurrently transferred through the electrolyte 230 contained in the separators 226 toward the positive electrodes 224. The electrons flow through the external circuit 40 and the lithium ions migrate across the separators 226 containing the electrolyte 230 to form intercalated lithium at the positive electrodes 224. As noted above, the electrolyte 230 is typically also present in the negative electrodes 222 and positive electrodes 224. The electric current passing through the external circuit 240 can be harnessed and directed through the load device 242 until the lithium in the first current collectors 232 and/or negative electrode 222 is depleted and the capacity of the hybridized battery 220 is diminished.

The hybridized battery 220 can be charged or re-energized at any time by connecting an external power source to the hybridized battery 220 to reverse the electrochemical reactions that occur during battery discharge. Connecting an external electrical energy source to the hybridized battery 220 promotes a reaction, for example, non-spontaneous oxidation of intercalated lithium, at the positive electrodes 224 so that electrons and lithium ions are produced. The lithium ions flow back toward the first current collectors 232 and/or negative electrodes 222 through the electrolyte 230 across the separators 226 to replenish the first current collectors 232 and/or negative electrode 222 with lithium (e.g., intercalated lithium) for use during the next battery discharge event. As such, a complete discharging event followed by a complete charging event is considered to be a cycle, where lithium ions are cycled between the positive electrodes 224 and the first current collectors 232 and/or negative electrodes 222. The external power source that may be used to charge the hybridized battery 220 may vary depending on the size, construction, and particular end-use of the hybridized battery 220. Some notable and exemplary external power sources include, but are not limited to, an AC-DC converter connected to an AC electrical power grid though a wall outlet and a motor vehicle alternator.

In many lithium-ion battery configurations, each of the first current collectors 232, negative electrodes 222, separators 226, positive electrodes 224, and second current collectors 234 can be prepared as relatively thin layers (for example, from several microns to a fraction of a millimeter or less in thickness) and assembled in layers connected in electrical parallel arrangement to provide a suitable electrical energy and power package. In various aspects, the hybridized battery 20 may also include a variety of other components that, while not depicted here, are nonetheless known to those of skill in the art. For instance, the hybridized battery 20 may include a casing, gaskets, terminal caps, tabs, battery terminals, and any other conventional components or materials that may be situated within the hybridized battery 20, including between or around the first current collectors 232, negative electrodes 222, the positive electrodes 224, and/or the separators 226.

The size and shape of the hybridized battery 220 may vary depending on the particular application for which it is designed. Battery-powered vehicles and hand-held consumer electronic devices, for example, are two examples where the hybridized battery 220 would most likely be designed to different size, capacity, and power-output specifications. The hybridized battery 220 may also be connected in series or parallel with other similar lithium-ion cells or batteries to produce a greater voltage output, energy, and power if it is required by the load device 242. Accordingly, the hybridized battery 220 can generate electric current to a load device 242 that is part of the external circuit 240. The load device 242 may be powered by the electric current passing through the external circuit 240 when the hybridized battery 220 is discharging. While the electrical load device 242 may be any number of known electrically-powered devices, a few specific examples include an electric motor for an electrified vehicle, a laptop computer, a tablet computer, a cellular phone, and cordless power tools or appliances. The load device 242 may also be an electricity-generating apparatus that charges the hybridized battery 220 for purposes of storing electrical energy.

Certain features of the current technology are further illustrated in the following non-limiting examples.

### Example 1

Example batteries and battery cells may be prepared in accordance with various aspects of the present disclosure.

For example, an example battery cell 310 may include first and second cells, where the first cell is a lithium-ion electrochemical cells (like the lithium electrochemical cell 20 illustrated in FIG. 1) and the second cell is anode-free, lithium-ion electrochemical cells (like the anode-free, lithium-ion electrochemical cell 120 illustrated in FIG. 2). A comparative battery cell 320 may also include first and second cells. However, the first and second cells of the comparative battery cell 320 are both lithium-ion electrochemical cells (like the lithium electrochemical cell 20 illustrated in FIG. 1).

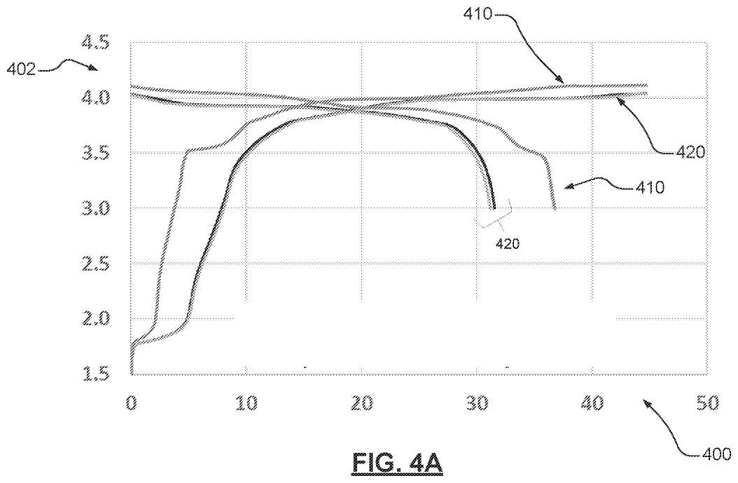

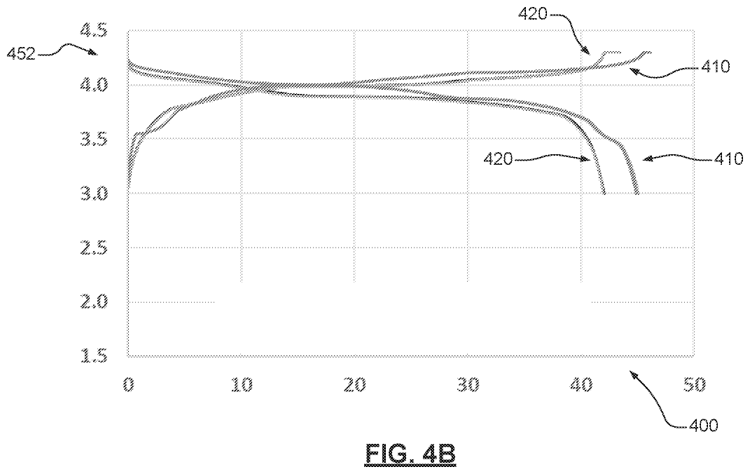

FIG. 4A is a graphical illustration demonstrating a formation cycle of the example battery cell 310, where the x-axis 300 represents capacity (mAh) and the y-axis 302 represents voltage (V). As illustrated, the example battery cell 310 consumes less active lithium in forming solid electrolyte interface layers on anode particles, such as graphite, as compared to the comparative battery cell 320. Further, as illustrated, the example battery cell 310 has a columbic efficiency (CE) of about 82.18%, where the comparative battery cell 320 has a columbic efficiency (CE) of only about 70.22%.

FIG. 4B is a graphical illustration demonstrating a first cycle after a formation cycle of the example battery cell 310, where the x-axis 350 represents capacity (mAh) and the y-axis 352 represents voltage (V), and where the charge C-rate is 0.1 C, and the discharge C-rate is 0.25 C. As illustrated, the example battery cell 310 displays an enhanced capacity and elevated average charge and discharge plateau as compared to the comparative battery cell 320. In other words, the example battery cell 310 has the benefit of improved energy density when compared to the comparative battery cell 320.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hybridized lithium-ion battery comprising:
one or more positive electrode assemblies, each of the one or more positive electrode assemblies comprising a positive electrode current collector and one or more positive electroactive material layers disposed on or near one or more surfaces of the positive electrode current collector;
two or more negative electrode current collectors,
one or more negative electroactive material layers disposed on or near one or more surfaces of at least one of the two or more negative electrode current collectors, wherein a total number of the one or more positive electroactive material layers is greater than a total number of negative electroactive material layers; and
two or more separating layers physically separating the positive electrode assemblies and the negative electroactive material layers or the positive electrode assemblies and the negative electrode current collectors.

2. The hybridized lithium-ion battery of claim 1, wherein a first positive electrode assembly of the one or more positive electrode assemblies together with a first negative electrode current collector of the two or more negative electrode current collectors, a first negative electroactive material layer of the one or more negative electroactive material layers disposed on or near a first surface of the first negative electrode current collector facing the positive electrode assembly, and a first separating layer of the two or more separating layers disposed between the positive electrode assembly and the first negative electroactive material layer define a first cell.

3. The hybridized lithium-ion battery of claim 2, wherein the first positive electrode assembly comprises a first positive electroactive material layer disposed on a first side of a second positive electrode current collector and a second positive electroactive material layer disposed on a second side of the second positive electrode current collector, the first positive electroactive material layer adjacent to the first separating layer, the second positive electroactive material layer together with a second negative electrode current collector of the two or more negative electrode current collectors, and a second separating layer of the two or more separating layers disposed between the second positive electroactive material layer and the second negative electrode current collector defining a second cell, the second negative electrode current collector contacting the second separating layer.

4. The hybridized lithium-ion battery of claim 3, wherein a second negative electroactive material layer of the one or more negative electroactive material layers is disposed on a surface of the second negative electrode current collector facing away from the second separating layer, the second negative electroactive material layer together with a second positive electrode assembly, and a third separating layer of the two or more separating layers disposed between the second negative electroactive material layer and the second positive electrode assembly defining a third cell.

5. The hybridized lithium-ion battery of claim 3, wherein a second negative electroactive material layer of the one or more negative electroactive material layers is disposed on a surface of the first negative electrode current collector, the second negative electroactive material layer together with a second positive electrode assembly, and a third separating layer of the two or more separating layers disposed between the second negative electroactive material layer and the second positive electrode assembly defining a third cell.

6. The hybridized lithium-ion battery of claim 2, wherein the first negative electrode current collector together with a second positive electrode assembly and a second separating layer of the two or more separating layers disposed between the first negative electrode current collector and the second positive electrode assembly defines a second cell, the second separating layer contacting the first negative electrode current collector.

7. The hybridized lithium-ion battery of claim 6, wherein the second positive electrode assembly comprises a first positive electroactive material layer disposed on a first side of a second positive electrode current collector and a second positive electroactive material layer disposed on a second side of the second positive electrode current collector, the first positive electroactive material layer adjacent to the second separating layer, the second positive electroactive material layer together with a second negative electrode current collector, and a third separating layer of the two or more separating layers disposed between the second positive electroactive material layer and the second negative electrode current collector defining a third cell.

8. The hybridized lithium-ion battery of claim 6, wherein a second negative electroactive material layer is disposed on a surface of the second negative electrode current collector facing away from the third separator, the second negative electroactive material layer together with a third positive electrode assembly and a fourth separating layer of the two or more separating layers disposed between the second negative electroactive material layer and the third positive electrode assembly defining a fourth cell.

9. The hybridized lithium-ion battery of claim 1, wherein the battery has a negative electrode capacity for lithium to positive electrode capacity for lithium (N/P) ratio of greater than 1.0.

10. A hybridized lithium-ion battery comprising:
a first cell comprising a first negative electrode current collector and a first positive electroactive material layer physically separated by a first separating layer, the first negative electrode current collector contacting the first separating layer;
a second cell comprising a second negative electrode current collector, a negative electroactive material layer disposed on a first side of the second negative electrode current collector, and a second positive electroactive material layer, the negative electroactive material layer and the positive electroactive material layer physically separated by a second separating layer; and
a positive electrode current collector disposed between the first positive electroactive material layer and the second positive electroactive material layer.

11. The hybridized lithium-ion battery of claim 10, wherein the negative electroactive material layer is a first negative electroactive material layer, the positive electrode current collector is a first positive electrode current collector, and the hybridized lithium-ion battery further comprises:
a second negative electroactive material layer adjacent to a surface of the first negative electrode current collector facing away from the first separating layer;
a positive electrode assembly comprising a third positive electroactive material layer and a second positive electrode current collector; and
a third separating layer physically separating the second electroactive material layer and the positive electrode assembly.

12. The hybridized lithium-ion battery of claim 10, wherein the negative electroactive material layer is a first negative electroactive material layer, the positive electrode current collector is a first positive electrode current collector, and the hybridized lithium-ion battery further comprises:
a second negative electroactive material layer adjacent to a second side of the second negative electrode current collector;
a positive electrode assembly comprising a third positive electroactive material layer and a second positive electrode current collector; and
a third separating layer physically separating the second electroactive material layer and the positive electrode assembly.

13. The hybridized lithium-ion battery of claim 10, wherein the positive electrode current collector is a first positive electrode current collector, and the hybridized lithium-ion battery further comprises:
a third separating layer adjacent to a side of the first negative electrode current collector facing away from the first separating layer; and
a positive electrode assembly adjacent to the third separating layer, the positive electrode assembly comprising a third positive electroactive material layer and a second positive electrode current collector.

14. The hybridized lithium-ion battery of claim 10, wherein the battery has a negative electrode capacity for lithium to positive electrode capacity for lithium (N/P) ratio of greater than 1.0.

15. A hybridized lithium-ion battery comprising:
a first positive electrode current collector;
a first positive electroactive material layer disposed on a surface of the first positive electrode current collector;
a first separating layer disposed on a surface of the first positive electroactive material layer;
a negative electroactive material layer disposed on a surface of the first separating layer;
a negative electrode current collector disposed on a surface of the negative electroactive material layer;
a second separating layer disposed on a surface of the first negative electrode current collector;
a second positive electroactive material layer disposed on a surface of the second separating layer; and
a second positive electrode current collector disposed on a surface of the second positive electroactive material layer.

16. The hybridized lithium-ion battery of claim 15, wherein the negative electroactive material layer is a first negative electroactive material layer, the negative electrode current collector is a first negative electrode current collector, and the battery further comprises:
a third positive electroactive material layer disposed on a surface of the second positive electrode current collector;
a third separating layer disposed on a surface of the third positive electroactive material layer;
a second negative electroactive material layer disposed on a surface of the third separating layer; and
a second negative electrode current collector disposed on a surface of the second negative electroactive material layer.

17. The hybridized lithium-ion battery of claim 15, wherein the negative electrode current collector is a first negative electrode current collector, and the battery further comprises:
a third positive electroactive material layer disposed on a surface of the second positive electrode current collector;
a third separating layer disposed on a surface of the third positive electroactive material layer; and
a second negative electrode current collector disposed on a surface of the third separating layer.

18. The hybridized lithium-ion battery of claim 17, wherein the negative electroactive material layer is a first negative electroactive material layer, and the battery further comprises:
a second negative electroactive material layer disposed on a surface of the second negative electrode current collector facing away from the third separating layer;
a fourth separating layer disposed on or near a surface of the second negative electroactive material layer;
a fourth positive electroactive material layer disposed on or near a surface of the fourth separating layer; and
a third positive electrode current collector disposed on or near a surface of the fourth positive electroactive material layer.

19. The hybridized lithium-ion battery of claim 15, wherein the negative electrode current collector is a first negative electrode current collector, and the battery further comprises:
a third positive electroactive material layer disposed on a surface of the first positive electrode current collector facing away from the first positive electroactive material layer;
a third separating layer disposed on the third positive electroactive material layer; and
a second negative electrode current collector disposed on the third separating layer.

20. The hybridized lithium-ion battery of claim 15, wherein the battery has a negative electrode capacity for lithium to positive electrode capacity for lithium (N/P) ratio of greater than 1.0.
